(19) United States
(12) Patent Application Publication
(10) Pub. No.: US 2026/0168801 A1
(43) Pub. Date: Jun. 18, 2026

(54) Route Search Method and Route Search Device

(71) Applicant: Hitachi, Ltd., Tokyo (JP)

(72) Inventor: Takaaki SEKIGUCHI, Tokyo (JP)

(21) Appl. No.: 19/404,878

(22) Filed: Dec. 1, 2025

(30) Foreign Application Priority Data
Dec. 13, 2024 (JP) 2024-218761

(51) Int. Cl. G01C 21/34

(52) U.S. Cl. CPC G01C 21/3453

(57) ABSTRACT

In a route search method executed by a computer system, the route search method includes: a preliminary search procedure of generating label data on the basis of link cost data and node cost data of a road network; and a route decision procedure of deciding a route between points on the basis of the label data, the preliminary search procedure includes a procedure of generating information regarding a hub, and a procedure of storing a cost at which a route connecting each node and the hub is connected to the hub, the cost being included in the label data, and the route decision procedure includes a procedure of deciding the route between the points with reference to a cost on the hub, a cost of a route connected to the hub, and a cost at which the route is connected to the hub.

### CLAIM OF PRIORITY

The present application claims priority from Japanese patent application JP2024-218761 filed on Dec. 13, 2024, the content of which is hereby incorporated by reference into this application.

### BACKGROUND OF THE INVENTION

### 1. Field of the Invention

The present invention relates to a route search technique.

### 2. Description of the Related Art

Traffic simulation on a road is performed for various purposes. As an example, there is a case where a traffic simulation on a road in a region including a predetermined route is performed in order to predict power consumption of an electric bus traveling along the route. At that time, a route search for creating a travel route of each vehicle traveling around the bus is performed.

Regarding the traffic simulation and the route search, for example, techniques disclosed in JP 2024-006151 A and US 2015/0347629 A are known.

JP 2024-006151 A discloses that “A computer executes simulations of traffic dynamics of a moving object a plurality of times by changing a value of a parameter. The computer executes each of the simulations for a predetermined number of steps or a predetermined time. The computer calculates a prediction time required for the completion of each of the simulations on the basis of information indicating the traffic dynamics obtained by the executed simulation. The computer preferentially executes, among each of the simulations, a simulation for which the calculated prediction time is short, after the predetermined number of steps or the predetermined time.”

US 2015/0347629 A describes a hub labeling technique in which a route between an arbitrary node and a hub is preliminarily searched, and in a case where a departure node and a destination node are decided, a hub for which a route to each of the nodes has already been searched is identified.

### SUMMARY OF THE INVENTION

In the traffic simulation, when a region with a large traffic volume, such as an urban region, is targeted, tens of thousands of vehicles may be handled as surrounding vehicles. In addition, if the route of each vehicle is created only once by a shortest route search algorithm, many vehicles concentrate on some roads such as national roads, resulting in a traffic situation that is far from reality. Therefore, in a general simulation, it is necessary to create a traffic situation close to reality by repeating, a plurality of times, a process of performing a simulation using the route created by the shortest route search algorithm, updating the cost of each road or the like on the basis of the result, performing a route search again using the updated cost, and performing a simulation again using the route. That is, since there is a case where it is necessary to perform a route search for tens of thousands of vehicles a plurality of times, a large amount of time is required for the route search, which makes speeding up the route search a challenge.

JP 2024-006151 A describes that, using the size and charge of a charging area as parameters, an evaluation with parameters for which a simulation time is predicted to be short is prioritized, thereby allowing the influence of each parameter to be understood at an early stage. Accordingly, the simulation time can be expected to be shortened. On the other hand, a large amount of time is required for a route search for performing a simulation as described above, but shortening of the time is not described.

According to the hub labeling technique described in US 2015/0347629 A, instead of performing preliminary search for all combinations between arbitrary nodes, preliminary search is performed for a route from an arbitrary node to a hub and a route from the hub to an arbitrary node. Then, in a case where the departure node and the destination node are decided, a hub for which both a route from the decided departure node and a route to the decided departure node are preliminarily searched is identified, and a route passing through the hub with the smallest cost becomes the shortest route. Accordingly, a calculation time after the departure node and the destination node are decided is shortened.

On the other hand, in the route search, it is also necessary to consider the cost of the node (that is, for example, the time required when going straight or making right or left turns at intersections). On the other hand, since hub labeling is a method of preliminarily searching for portions before and after the hub as described above, it is not possible to perform the route search in consideration of the cost of the hub itself.

For example, in a case where there are a departure node, a destination node, and a plurality of hubs (nodes different from both the departure node and the destination node), a cost of a route from the departure node to each hub and a cost of a route from each hub to the destination node are calculated in advance, and are respectively stored as a departure-side label and a destination-side label to be described later. Then, a combination having the lowest cost among combinations of the departure-side label and the destination-side label connected to the same hub is generated as a route. At this time, a cost of passing through the hub itself may vary depending on, for example, whether a combination of a route for entering the hub and a route for leaving the hub is straight travel, right turn, or left turn. However, whether passing through the hub corresponds to straight travel, right turn, or left turn is determined by the combination of the departure-side label and the destination-side label, so that the cost of passing through the hub cannot be included in the departure-side label and the destination-side label in advance.

Note that, although the route search for traffic simulation is used as an example in the above problem, a similar problem may occur in a case where a large amount of route search needs to be performed in a short time, for example, in a case where a distribution company decides travel routes of a large number of vehicles of the company.

To solve at least one of the above-mentioned problems, the present invention is a route search method executed by a computer system including a processor and a storage device, wherein the storage device stores link cost data including a cost of a link included in a road network and node cost data including a cost of a node included in the road network, the route search method comprises a preliminary search procedure in which the processor generates label data on a basis of the link cost data and the node cost data; and a route decision procedure in which the processor decides a route between points on a basis of the label data, the preliminary search procedure includes a first procedure in which the processor generates information regarding a hub including one or more nodes of the road network, on a basis of the link cost data and the node cost data, and a second procedure in which the processor stores, for each node included in the road network, a cost at which a route connecting each node and the hub is connected to the hub, the cost being included in the label data, on a basis of the link cost data and the node cost data, and the route decision procedure includes a third procedure in which the processor decides the route between the points with reference to a cost on the hub, a cost of a route connected to the hub, and a cost at which the route is connected to the hub.

According to one aspect of the present invention, it is possible to perform a highly accurate route search also including the cost of each node, while reducing the time required for the route search after the departure and the destination are identified.

Problems, configurations, and effects other than those described above will be clarified by the following description of embodiments.

### BRIEF DESCRIPTION OF THE DRAWINGS

FIG. 1 is a functional block diagram illustrating an example of a configuration of a traffic simulation device according to an embodiment of the present invention.

FIG. 2 is a block diagram illustrating an example of a hardware configuration for implementing a traffic simulation device according to the embodiment of the present invention.

FIG. 3 is an explanatory diagram illustrating an example of a link cost data stored by the traffic simulation device according to the embodiment of the present invention.

FIG. 4 is an explanatory diagram illustrating an example of a data structure of the link cost data stored by the traffic simulation device according to the embodiment of the present invention.

FIG. 5 is an explanatory diagram illustrating an example of a node cost data stored by the traffic simulation device according to the embodiment of the present invention.

FIG. 6 is an explanatory diagram illustrating an example of a data structure of the node cost data stored by the traffic simulation device according to the embodiment of the present invention.

FIG. 7 is an explanatory diagram illustrating an example of a hub set on a road network by the traffic simulation device according to the embodiment of the present invention.

FIG. 8 is an explanatory diagram illustrating an example of a data structure of a hub data stored by the traffic simulation device according to the embodiment of the present invention.

FIG. 9 is an explanatory diagram illustrating an example of a data structure of a departure-side label data stored by the traffic simulation device according to the embodiment of the present invention.

FIG. 10 is an explanatory diagram illustrating an example of a data structure of a destination-side label data stored by the traffic simulation device according to the embodiment of the present invention.

FIGS. 11A and 11B are flowcharts illustrating an example of processing executed by a preliminary search unit of the traffic simulation device according to the embodiment of the present invention.

FIGS. 12A and 12B are explanatory diagrams illustrating specific examples of generation of the departure-side label data by the preliminary search unit of the traffic simulation device according to the embodiment of the present invention.

FIGS. 13A and 13B are explanatory diagrams illustrating specific examples of generation of the destination-side label data by the preliminary search unit of the traffic simulation device according to the embodiment of the present invention.

FIG. 14 is an explanatory diagram of a method of calculating a forward connection cost on the departure side by the preliminary search unit of the traffic simulation device according to the embodiment of the present invention.

FIG. 15 is a flowchart illustrating an example of the processing executed by a route decision unit of the traffic simulation device according to the embodiment of the present invention.

FIG. 16 is a flowchart illustrating an example of cost comparison processing executed by the route decision unit of the traffic simulation device according to the embodiment of the present invention.

FIG. 17 is an explanatory diagram illustrating an example of a result of cost comparison processing executed by the route decision unit of the traffic simulation device according to the embodiment of the present invention.

FIG. 18 is a flowchart illustrating an example of connection cost verification processing executed by the route decision unit of the traffic simulation device according to the embodiment of the present invention.

FIG. 19 is an explanatory diagram illustrating an example of a route generated by the route decision unit of the traffic simulation device according to the embodiment of the present invention.

### DESCRIPTION OF THE PREFERRED EMBODIMENTS

Hereinafter, embodiments of the present invention will be described with reference to the drawings.

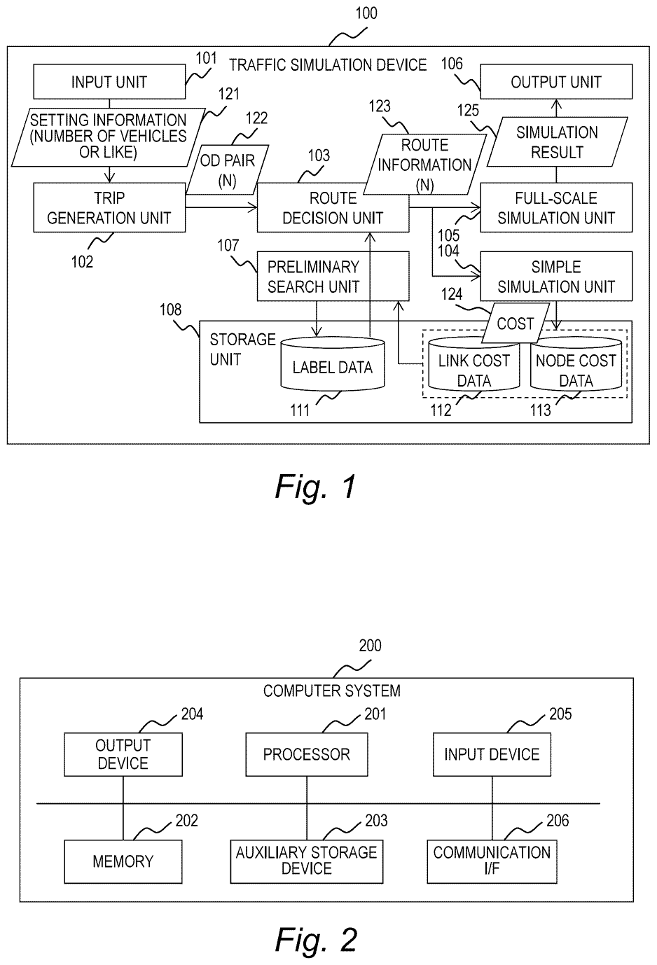

FIG. 1 is a functional block diagram illustrating an example of a configuration of a traffic simulation device according to an embodiment of the present invention.

A traffic simulation device 100 of the present embodiment includes an input unit 101, a trip generation unit 102, a route decision unit 103, a simple simulation unit 104, a full-scale simulation unit 105, an output unit 106, a preliminary search unit 107, and a storage unit 108. The storage unit 108 stores label data 111, link cost data 112, and node cost data 113.

The input unit 101 receives an input of setting information 121 from a user, and passes the input to the trip generation unit 102. The setting information 121 includes information such as the number of vehicles traveling on a road in the simulation. The trip generation unit 102 generates a pair (OD pair) 122 of a departure (Origin) and a destination (Destination) of each vehicle on the basis of the setting information 121 and passes the pair to the route decision unit 103. For example, in a case where the number of vehicles is set to N in the setting information 121, N OD pairs 122 are generated.

The route decision unit 103 generates route information 123 on the basis of the OD pair 122 and the label data 111, and passes the route information 123 to the simple simulation unit 104 or the full-scale simulation unit 105. For example, the route information 123 including N routes corresponding to the N OD pairs 122 is generated. The label data 111 is generated by the preliminary search unit 107 as described later.

The simple simulation unit 104 executes a traffic simulation on the basis of the route information 123, the link cost data 112, and the node cost data 113, calculates a cost 124 of each link and node of a road network on the basis of the result, and updates the link cost data 112 and the node cost data 113 accordingly.

For example, a passing time of each link and node when the vehicle travels at a legal speed is set as the initial value of the link cost data 112 and the node cost data 113, the simple simulation unit 104 executes a traffic simulation on the basis of the initial value, and the link cost data 112 and the node cost data 113 are updated by the passing time (that is, the cost 124) of each link and node obtained as a result of the simulation. Every time the link cost data 112 and the node cost data 113 are updated, the preliminary search unit 107 may update the label data 111 on the basis of the updated link cost data 112 and node cost data 113, and the route decision unit 103 may update the route information 123 on the basis of the updated label data 111.

The simple simulation unit 104 repeatedly executes the traffic simulation and updating of the link cost data 112 and the node cost data 113 based on the result of the traffic simulation until a predetermined condition is satisfied. For example, the execution may be repeated a predetermined number of times, or may be repeated until a value of the cost converges.

The full-scale simulation unit 105 executes the traffic simulation based on the link cost data 112 and the node cost data 113 updated by the simple simulation unit 104, and passes a simulation result 125 to the output unit 106. Specifically, the preliminary search unit 107 generates the label data 111 on the basis of the link cost data 112 and the node cost data 113 updated by the simple simulation unit 104, the route decision unit 103 generates the route information 123 corresponding to the N OD pairs 122 on the basis of the label data, and the full-scale simulation unit 105 executes the traffic simulation on the basis of the route information 123.

The output unit 106 outputs the simulation result 125 to the user.

The preliminary search unit 107 performs preliminary search for hub labeling on the basis of the link cost data 112 and the node cost data 113, and stores a generated label as the label data 111 in the storage unit 108. Details of the link cost data 112, the node cost data 113, and the label data 111 and details of processing of the preliminary search unit 107 will be described later.

Note that in the present embodiment, a route search for the purpose of traffic simulation will be described, but the present invention can be applied to a route search for any purpose. For example, a distribution company may perform a route search by the same method as in the present embodiment in order to decide delivery routes of many trucks of the company. As described above, in a case where it is assumed that a route search for an arbitrary purpose is performed without being limited to the traffic simulation, the traffic simulation device 100 may be replaced with a route search device 100.

FIG. 2 is a block diagram illustrating an example of a hardware configuration for implementing the traffic simulation device 100 according to the embodiment of the present invention.

The traffic simulation device 100 of the present embodiment illustrated in FIG. 1 can be implemented by a computer system. FIG. 2 illustrates a computer system 200 as an example.

The computer system 200 includes a processor 201, a memory (main storage device) 202, an auxiliary storage device 203, an output device 204, an input device 205, and a communication interface (I/F) 206. The above components are connected to each other by a bus. The memory 202 and the auxiliary storage device 203 are storage devices, and store programs and data used by the processor 201. The memory 202 and the auxiliary storage device 203 correspond to the storage unit 108 in FIG. 1.

The memory 202 includes, for example, a semiconductor memory, and is mainly used to store a program and data being executed. For example, the program and data stored in the auxiliary storage device 203 are loaded into the memory 202 at the time of startup or when necessary. The processor 201 executes various types of processing according to the program stored in the memory 202. The processor 201 operates according to the program, thereby implementing various functional units (for example, the input unit 101, the trip generation unit 102, the route decision unit 103, the simple simulation unit 104, the full-scale simulation unit 105, the output unit 106, and the preliminary search unit 107 illustrated in FIG. 1).

The auxiliary storage device 203 includes, for example, a large-capacity storage device such as a hard disk drive or a solid state drive, and is used to store a program and data for a long period of time. For example, the label data 111, the link cost data 112, the node cost data 113, the setting information 121, the OD pair 122, the route information 123, and the like may be stored in the auxiliary storage device 203.

The processor 201 may be composed of a single processing unit or a plurality of processing units, and may include a single or more arithmetic units or a plurality of processing cores. The processor 201 may be implemented as one or more central processing units, a microprocessor, a microcomputer, a microcontroller, a digital signal processor, a state machine, a logic circuit, a graphical processing unit, a chip-on-system, and/or any device that manipulates a signal based on a control instruction.

The input device 205 is a hardware device for the user to input an instruction, information, and the like. The output device 204 is a hardware device that presents various images for input and output, and is, for example, a display device or a print device. For example, the processor controls the input device 205 and the output device 204 according to a program, thereby implementing the functions of the input unit 101 and the output unit 106. The communication I/F 206 is an interface for connection to a communication network (not illustrated).

Note that the computer system 200 may include two or more processors 201. In addition, the function of the traffic simulation device 100 can be implemented in a plurality of computer systems 200. In this case, the plurality of computer systems 200 communicate via a communication network. For example, a part of a plurality of functions of the system of the present embodiment may be implemented in one computer system 200, and another part may be implemented in another computer system 200.

For example, the computer system 200 may be a personal computer (PC) owned by an operator (for example, a public transportation operator or the like) of the traffic simulation device 100 of the present embodiment, or may be a server or the like accessed by the operator via a communication network. In the latter case, the computer system 200 may be a virtual server or the like on a so-called cloud. In this case, the computer system 200 illustrated in FIG. 1 is implemented by computer resources on a cloud.

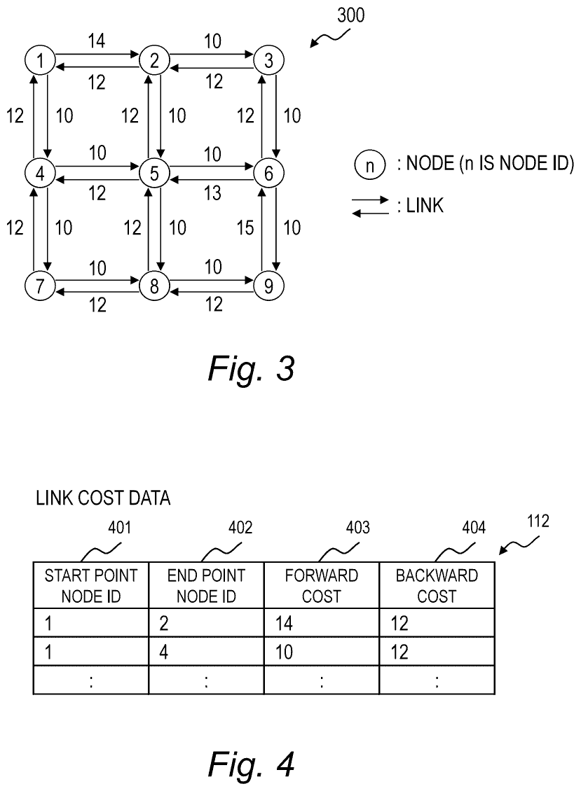

Next, the link cost data 112 and the node cost data 113 will be described with reference to FIGS. 3 to 6.

FIG. 3 is an explanatory diagram illustrating an example of the link cost data 112 stored by the traffic simulation device 100 according to the embodiment of the present invention.

FIG. 3 illustrates a road network 300 exemplified for description of the present embodiment. In FIG. 3, a circular figure indicates a node, and an arrow connecting nodes indicates a link. For example, the node corresponds to an intersection, and the link corresponds to a section of a road connecting the intersections. The number described on the node is an identification number (node ID) of the node. In the following description, for example, a node identified by the node ID “1” will be described as “node 1”.

In the example of FIG. 3, two arrows with opposite directions are displayed between two nodes. This indicates one link that can be traveled in both directions between two nodes (that is, a start point node and an end point node). The number displayed in the vicinity of each arrow is the cost when traveling along each link in each direction. The cost may represent, for example, the length of the time required when the vehicle travels between the start point node and the end point node of each link in the direction of the arrow.

FIG. 4 is an explanatory diagram illustrating an example of a data structure of the link cost data 112 stored by the traffic simulation device 100 according to the embodiment of the present invention.

The link cost data 112 includes, for example, a plurality of records each corresponding to each link. Each record includes a start point node ID 401, an end point node ID 402, a forward cost 403, and a backward cost 404. The start point node ID 401 and the end point node ID 402 indicate identification numbers of nodes at the start point and the end point of each link, respectively. The forward cost 403 indicates the cost when traveling along each link in a forward direction. The backward cost 404 indicates the cost when traveling along each link in a backward direction. Note that in the present embodiment, a direction from the start point node to the end point node is referred to as the “forward direction”, and the opposite direction is referred to as the “backward direction”.

The first record in FIG. 4 indicates that the cost of traveling along a link having the node 1 as the start point and a node 2 as the end point in the forward direction is 14 and the cost of traveling along the link in the backward direction is 12. Similarly, the second record indicates that the cost of traveling along a link having the node 1 as the start point and a node 4 as the end point in the forward direction is 10 and the cost of traveling along the link in the backward direction is 12. These correspond to the example illustrated in FIG. 3. Although not illustrated in FIG. 4, costs of other links are also recorded in the link cost data 112.

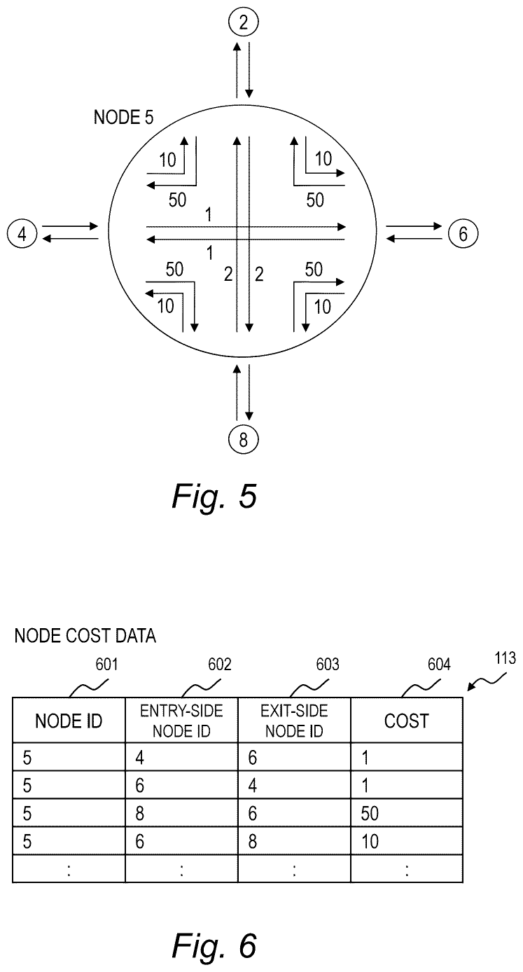

FIG. 5 is an explanatory diagram illustrating an example of the node cost data 113 stored by the traffic simulation device 100 according to the embodiment of the present invention.

The cost of a node is set for each combination of an entry direction to the node and an exit direction from the node. FIG. 5 illustrates the cost of a node 5 illustrated in FIG. 3 as an example. In this example, the cost for the case of entering from the node 4, going straight through the node 5, and exiting to a node 6 is “1”. The cost for the case of entering from the node 6, going straight through the node 5, and exiting to the node 4 is “1”. The cost for the case of entering from a node 8, turning right at the node 5, and exiting to the node 6 is “50”. The cost for the case of entering from the node 6, turning left at the node 5, and exiting to the node 8 is “10”. Similarly, costs corresponding to all combinations of an entry direction to the node 5 and an exit direction from the node 5 are set.

Note that, although all the nodes actually have costs, in the present embodiment, the costs of all the nodes other than the node 5 are set to “0” in order to simplify the description.

FIG. 6 is an explanatory diagram illustrating an example of a data structure of the node cost data 113 stored by the traffic simulation device 100 according to the embodiment of the present invention.

The node cost data 113 includes, for example, a plurality of records each corresponding to a combination of the entry direction and the exit direction of each node. Each record includes a node ID 601, an entry-side node ID 602, an exit-side node ID 603, and a cost 604. This indicates the cost 604 for the case of entering the node indicated by the node ID 601 from the node indicated by the entry-side node ID 602 and exiting to the node indicated by the exit-side node ID 603.

FIG. 6 illustrates a part of the cost of the node 5 illustrated in FIG. 5. For example, a first record in the example of FIG. 6 indicates that the cost for the case of entering from the node 4, traveling straight through the node 5, and exiting to the node 6 is “1”. Similarly, for each node, the cost of each combination of the entry direction and the exit direction is recorded in the node cost data 113.

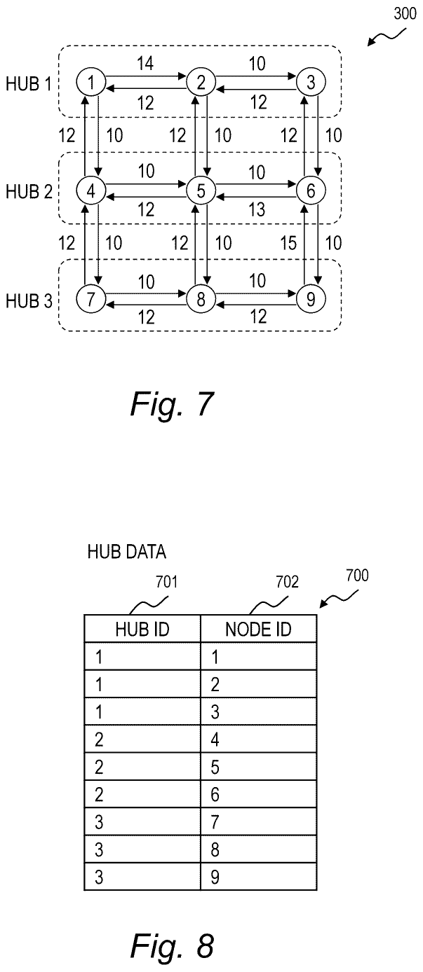

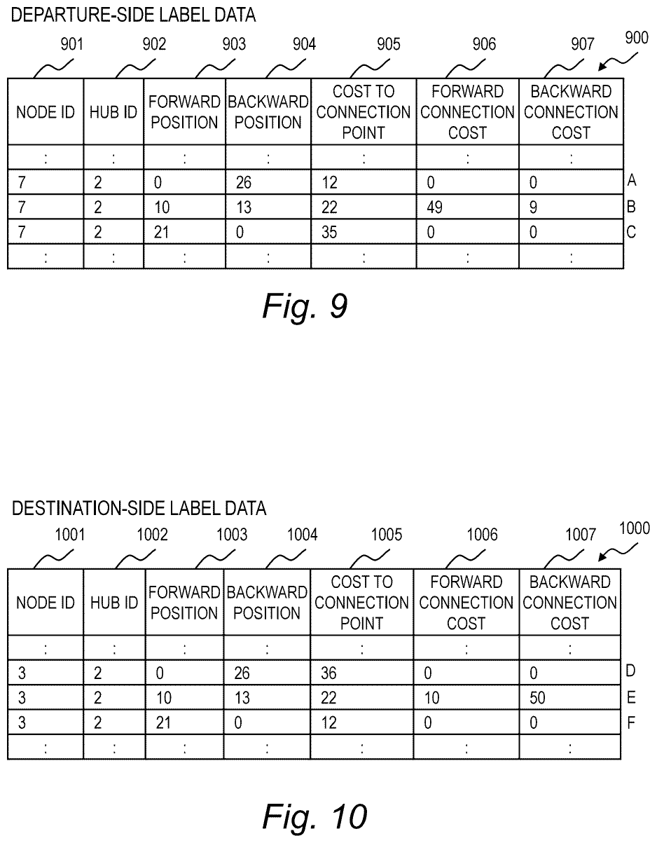

Next, the label data 111 will be described with reference to FIGS. 7 to 10. The label data 111 includes hub data 800 illustrated in FIG. 8, departure-side label data 900 illustrated in FIG. 9, and destination-side label data 1000 illustrated in FIG. 10.

FIG. 7 is an explanatory diagram illustrating an example of a hub set on a road network by the traffic simulation device 100 according to the embodiment of the present invention.

FIG. 7 illustrates an example of a hub set on the road network 300 illustrated in FIG. 3. In this example, three hubs (hereinafter, described as “hub 1” to “hub 3”) identified by hub IDs “1” to “3” are set. The hub 1 includes the node 1, the node 2, the node 3, and two links connecting them. The hub 2 includes the node 4, the node 5, the node 6, and two links connecting them. The hub 3 includes a node 7, a node 8, a node 9, and two links connecting them. In FIG. 7, each hub is surrounded by a broken line.

Note that in each hub, a start point and an end point are determined in advance. For example, in the hub 1, the node 1 is the start point, and the node 3 is the end point. In this case, in a traveling direction in the hub 1, a direction from the node 1 as the start point to the node 3 as the end point is the forward direction, and the opposite direction is the backward direction. Similarly, in the hub 2, the node 4 is the start point and the node 6 is the end point, and in the hub 3, the node 7 is the start point and the node 9 is the end point.

FIG. 8 is an explanatory diagram illustrating an example of a data structure of the hub data 800 stored by the traffic simulation device 100 according to the embodiment of the present invention.

The hub data 800 includes a hub ID 801 and a node ID 802. The hub ID 801 is an identification number of the set hub. The node ID 802 is an identification number of a node belonging to the set hub. FIG. 8 illustrates information defining the hubs 1 to 3 illustrated in FIG. 7.

FIG. 9 is an explanatory diagram illustrating an example of a data structure of the departure-side label data 900 stored by the traffic simulation device 100 according to the embodiment of the present invention.

In the departure-side label data 900, for each of combinations of a plurality of departure nodes and a plurality of hubs, a label indicating a result of preliminary search of a route from the departure node to the hub is stored. Each label includes a node ID 901, a hub ID 902, a forward position 903, a backward position 904, a cost to connection point 905, a forward connection cost 906, and a backward connection cost 907.

The node ID 901 and the hub ID 902 are identification numbers of the departure node and the hub of a route search target. The forward position 903 and the backward position 904 indicate a forward position and a backward position in the hub, respectively, of a node to which the searched route is connected (hereinafter, also referred to as a connection point), among nodes included in the hub as the route search target. Here, in the hub to which the connection point belongs, the forward position is a sum of the cost of the link and the cost of the node (however, the cost of the connection point node is not included) on the route from the start point of the hub to the connection point. On the other hand, in the hub to which the connection point belongs, the backward position is a sum of the cost of the link and the cost of the node (however, the cost of the connection point node is not included) on the route from the end point of the hub to the connection point.

The cost to connection point 905 indicates the cost from the departure node of the searched route to the connection point. For example, the sum of the cost of the link and the cost of the node (however, the cost of the connection point node is not included) on the route from the departure node to the connection point is stored as the cost to connection point 905.

The forward connection cost 906 indicates the cost of the connection point node for the case of entering the hub from the connection point and traveling through the hub in the forward direction. The backward connection cost 907 indicates the cost of the connection point node for the case of entering the hub from the connection point and traveling through the hub in the backward direction.

Note that, in the present embodiment, the forward connection cost 906 is a value obtained by subtracting the cost of the connection point node for the case of traveling through the connection point node in the hub in the forward direction from the cost of the connection point node for the case of entering the hub from the connection point and traveling through the hub in the forward direction. For example, in a case where the connection point is the node 5, the forward connection cost 906 is “49” obtained by subtracting the cost “1” of the node 5 when traveling in the direction of the node 6 from the node 4 via the node 5 from the cost “50” of the node 5 when traveling in the direction of the node 6 from the node 8 via the node 5.

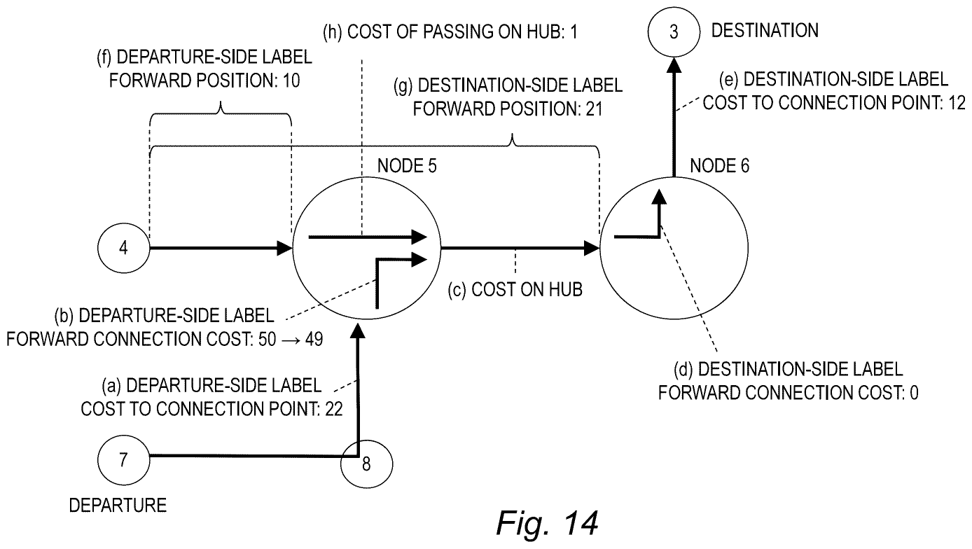

Similarly, the backward connection cost 907 is a value obtained by subtracting the cost of the connection point node for the case of traveling through the connection point node in the hub in the backward direction from the cost of the connection point node for the case of entering the hub from the connection point and traveling through the hub in the backward direction. The necessity of such subtraction will be described later with reference to FIG. 14. This subtraction may be performed not for the forward connection cost 906 and the backward connection cost 907 on the departure side, but for a forward connection cost 1006 and a backward connection cost 1007 on the destination side described later.

FIG. 10 is an explanatory diagram illustrating an example of a data structure of the destination-side label data 1000 stored by the traffic simulation device 100 according to the embodiment of the present invention.

In the destination-side label data 1000, for each of combinations of a plurality of destination nodes and a plurality of hubs, a label indicating a result of preliminary search of a route from the hub to the destination node is stored. Each label includes a node ID 1001, a hub ID 1002, a forward position 1003, a backward position 1004, a cost to connection point 1005, the forward connection cost 1006, and the backward connection cost 1007.

The node ID 1001 and the hub ID 1002 are identification numbers of the destination node and the hub of a route search target. The forward position 1003 and the backward position 1004 indicate a forward position and a backward position in the hub, respectively, of a node (connection point) to which the searched route is connected, among nodes included in the hub as the route search target.

The cost to connection point 1005 indicates the cost from the connection point of the searched route to the destination node. For example, the sum of the cost of the link and the cost of the node (however, the cost of the connection point node is not included) on the route from the connection point to the destination node is stored as the cost to connection point 1005.

The forward connection cost 1006 indicates the cost of the connection point node for the case of traveling through the hub in the forward direction to the connection point and exiting from the hub through the connection point. The backward connection cost 1007 indicates the cost of the connection point node for the case of traveling through the hub in the backward direction to the connection point and exiting from the hub through the connection point.

Note that A to F displayed on the right of records of the departure-side label data 900 in FIG. 9 and the destination-side label data 1000 in FIG. 10 are not a part of each data, but are identifiers attached to the records for reference in the following description. A specific numerical example of the records will be described later.

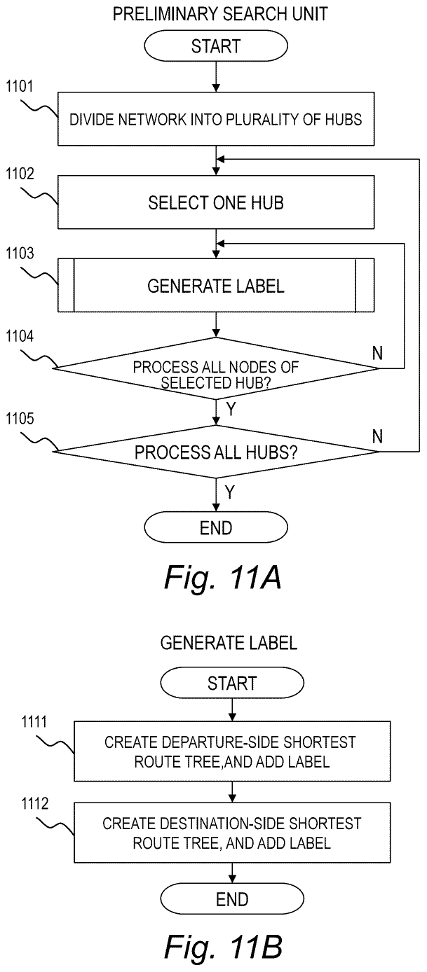

FIGS. 11A and 11B are flowcharts illustrating an example of processing executed by the preliminary search unit 107 of the traffic simulation device 100 according to the embodiment of the present invention.

First, the preliminary search unit 107 divides the road network into a plurality of hubs, and adds the hub data 800 generated as a result to the label data 111 (step 1101). At this time, the preliminary search unit 107 performs division such that at least two nodes connected via a link are included in each hub. In a case where the hub includes three or more nodes, the nodes need to be connected in series via links. For example, a hub is a continuous road section represented by a plurality of nodes connected by links.

A method of generating the hub is not limited. It is sufficient that the connection between the nodes constituting the hub is the shortest route. For example, the hub may be generated by a procedure of generating the shortest route with the node 1 as a start point and the maximum number of nodes as 3.

In the examples of FIGS. 7 and 8, the road network 300 is divided into the hub 1 including the nodes 1, 2, and 3, the hub 2 including the nodes 4, 5, and 6, and the hub 3 including the nodes 7, 8, and 9.

Next, the preliminary search unit 107 selects one hub (step 1102) and generates a label for the selected hub (step 1103). Specifically, the preliminary search unit 107 creates a departure-side shortest route tree to a hub selected from the departure node, and adds the departure-side label data 900 generated as a result to the label data 111 (step 1111). Further, the preliminary search unit 107 creates a destination-side shortest route tree from the selected hub to the destination node, and adds the destination-side label data 1000 generated as a result to the label data 111 (step 1112).

Next, the preliminary search unit 107 determines whether all the nodes of the selected hub have been processed (step 1104), and in a case where there is an unprocessed node (step 1104: No), the preliminary search unit 107 executes step 1103 for the node. In a case where all the nodes of the selected hub have been processed (step 1104: Yes), the preliminary search unit 107 determines whether all the hubs have been processed (step 1105). In a case where there is an unprocessed hub (step 1105: No), the preliminary search unit 107 executes step 1102 and step 1103 for the hub. In a case where all the hubs have been processed (step 1105: Yes), the processing of the preliminary search unit 107 ends.

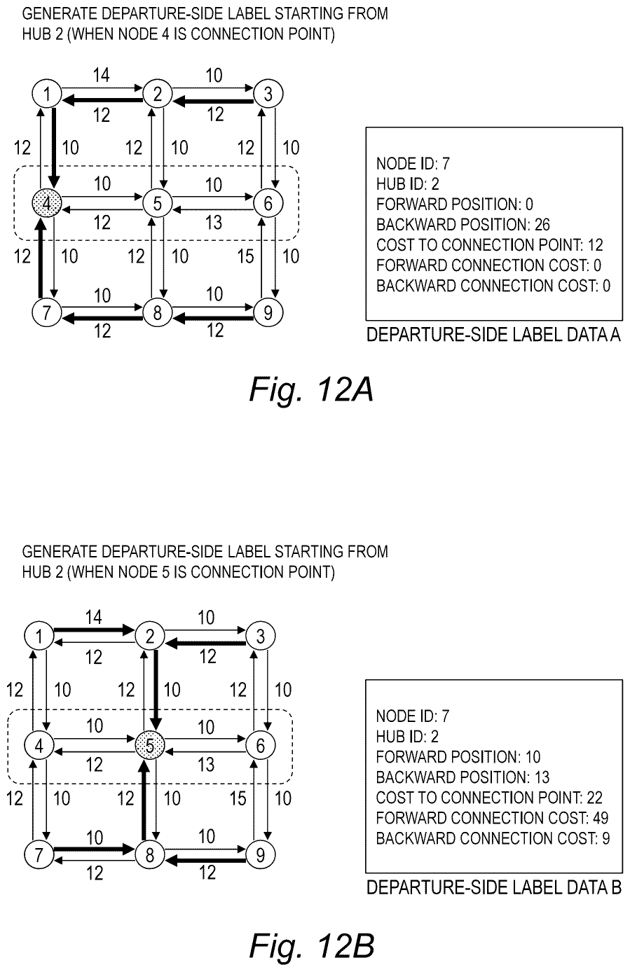

FIGS. 12A and 12B are explanatory diagrams illustrating specific examples of generation of the departure-side label data 900 by the preliminary search unit 107 of the traffic simulation device 100 according to the embodiment of the present invention.

FIGS. 12A and 12B illustrate an example of a part of the processing executed in step 1111 in a case where the hub 2 is selected among the hubs set in the road network 300 in step 1102.

First, a route in which the connection point is the node 4 will be described with reference to FIG. 12A. In this case, in step 1111, a route from the node 3 to the node 4 sequentially via the node 2 and the node 1 and a route from the node 9 to the node 4 sequentially via the node 8 and the node 7 are obtained as the shortest route tree (that is, a set of each node on the road network 300 as a departure node and the shortest of routes of entering the hub 2 from the node 4) to the node 4 which is the connection point.

In this example, since any of the nodes 1, 2, 3, 7, 8, and 9 can be a departure node, the preliminary search unit 107 generates label data in a case where each of the nodes is set as a departure node and stores the label data in the departure-side label data 900. In FIG. 12A, the label data generated in a case where the node 7 is a departure node will be described.

In this example, since the node 4 which is the connection point is the start point of the hub 2, the forward position 903 of the connection point is “0”. On the other hand, the backward position 904 is “26” which is the sum of the cost of the link from the node 6, which is the end point of the hub 2, to the node 4 and the cost of the node. This is the sum of the cost “13” of the link from the node 6 to the node 5, the cost “1” of the node 5 when entering the node 5 from the node 6 and exiting to the node 4 (see FIG. 5), and the cost “12” of the link from the node 5 to the node 4.

The cost to connection point 905 is the cost “12” of the link from the node 7 to the node 4. As described above, since the cost of the node 4 itself is “0”, both the forward connection cost 906 and the backward connection cost 907 are “O”. Label data A (see FIG. 9) thus generated is recorded in the departure-side label data 900.

Next, a route in which the connection point is the node 5 will be described with reference to FIG. 12B. In this case, in step 1111, a route from the node 1 to the node 5 via the node 2, a route from the node 3 to the node 5 via the node 2, a route from the node 7 to the node 5 via the node 8, and a route from the node 9 to the node 5 via the node 8 are obtained as the shortest route tree to the node 5 which is the connection point.

In this example, since any of the nodes 1, 2, 3, 7, 8, and 9 can be a departure node, the preliminary search unit 107 generates label data in a case where each of the nodes is set as a departure node and stores the label data in the departure-side label data 900. In FIG. 12B, the label data generated in a case where the node 7 is a departure node will be described.

In this example, the forward position 903 of the node 5, which is the connection point, is the cost “10” of the link from the node 4, which is the start point of the hub 2, to the node 5. On the other hand, the backward position 904 is the cost “13” of the link from the node 6, which is the end point of the hub 2, to the node 5.

The cost to connection point 905 is “22” that is the sum of the cost of the link from the node 7 to the node 5 and the cost of the node. This is the sum of the cost “10” of the link from the node 7 to the node 8, the cost “0” of the node 8, and the cost “12” of the link from the node 8 to the node 5.

The forward connection cost 906 is a value “49” obtained by subtracting the cost “1” (see FIG. 5) of the node 5 when entering the node 5 from the node 4 and traveling in the hub 2 in the forward direction from the cost “50” (see FIG. 5) of the node 5 when entering the node 5 from the node 8 and traveling in the hub 2 in the forward direction (that is, in the direction of the node 6). The backward connection cost 907 is a value “9” obtained by subtracting the cost “1” (see FIG. 5) of the node 5 when entering the node 5 from the node 6 and traveling in the hub 2 in the forward direction from the cost “10” (see FIG. 5) of the node 5 when entering the node 5 from the node 8 and traveling in the hub 2 in the backward direction (that is, in the direction of the node 4). The reason why this subtraction is necessary will be described later (see FIG. 14). Label data B (see FIG. 9) thus generated is recorded in the departure-side label data 900.

Although detailed description is omitted, label data C illustrated in FIG. 9 is also generated by the same processing as described above. The label data C is label data in a case where the departure is the node 7 and the connection point is the node 6, and the forward position 903 is “21”, the backward position 904 is “0”, the cost to connection point 905 is “35”, the forward connection cost 906 is “0”, and the backward connection cost 907 is “0”.

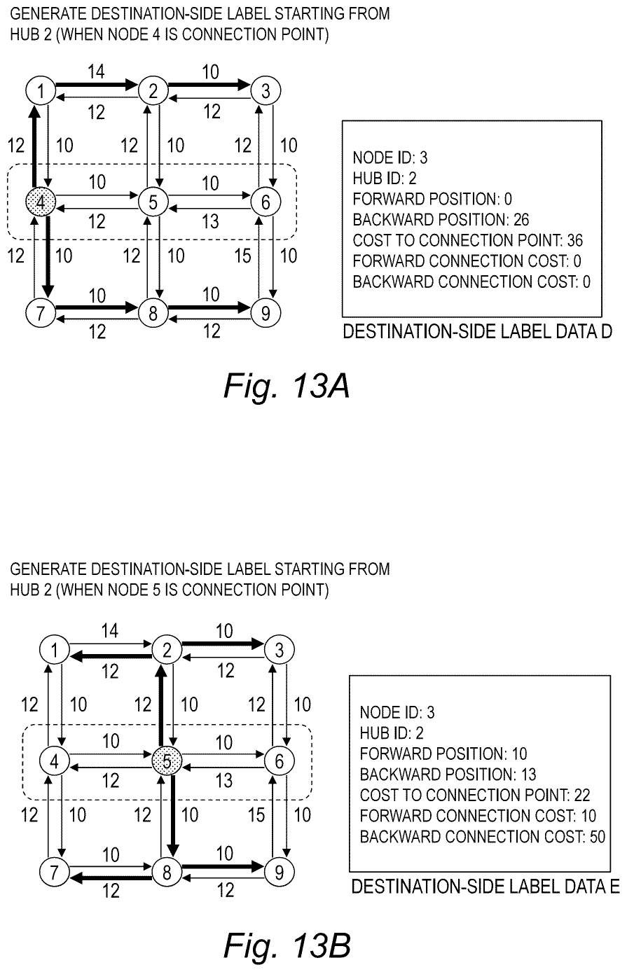

FIGS. 13A and 13B are explanatory diagrams illustrating specific examples of generation of the destination-side label data 1000 by the preliminary search unit 107 of the traffic simulation device 100 according to the embodiment of the present invention.

FIGS. 13A and 13B illustrate an example of a part of the processing executed in step 1112 in a case where the hub 2 is selected among the hubs set in the road network 300 in step 1102.

First, a route in which the connection point is the node 4 will be described with reference to FIG. 13A. In this case, in step 1112, a route from the node 4 to the node 3 sequentially via the node 1 and the node 2 and a route from the node 4 to the node 9 sequentially via the node 7 and the node 8 are obtained as the shortest route tree (that is, a set of each node on the road network 300 as a destination node and the shortest of routes of exiting from the hub 2 through the node 4) from the node 4 which is the connection point.

In this example, since any of the nodes 1, 2, 3, 7, 8, and 9 can be a destination node, the preliminary search unit 107 generates label data in a case where each of the nodes is set as a destination node and stores the label data in the destination-side label data 1000. In FIG. 13A, the label data generated in a case where the node 3 is a destination node will be described.

In this example, since the node 4 which is the connection point is the start point of the hub 2, the forward position 1003 of the connection point is “0”. On the other hand, the backward position 1004 is “26” which is the sum of the cost of the link from the node 6, which is the end point of the hub 2, to the node 4 and the cost of the node.

The cost to connection point 1005 is “36” that is the sum of the cost of the link from the node 4 to the node 3 and the cost of the node. This is a value obtained by adding the cost “12” of the link from the node 4 to the node 1, the cost “O” of the node 1, the cost 14 of the link from the node 1 to the node 2, the cost “0” of the node 2, and the cost “10” of the link from the node 2 to the node 3.

In addition, since the cost of the node 4 itself is “0”, both the forward connection cost 1006 and the backward connection cost 1007 are “0”. Label data D (see FIG. 10) thus generated is recorded in the destination-side label data 1000.

Next, a route in which the connection point is the node 5 will be described with reference to FIG. 13B. In this case, in step 1112, a route from the node 5 to the node 1 via the node 2, a route from the node 5 to the node 3 via the node 2, a route from the node 5 to the node 7 via the node 8, and a route from the node 5 to the node 9 via the node 8 are obtained as the shortest route tree from the node 5 which is the connection point.

In this example, since any of the nodes 1, 2, 3, 7, 8, and 9 can be a destination node, the preliminary search unit 107 generates label data in a case where each of the nodes is set as a destination node and stores the label data in the destination-side label data 1000. In FIG. 13B, the label data generated in a case where the node 3 is a destination node will be described.

In this example, the forward position 1003 of the node 5, which is the connection point, is the cost “10” of the link from the node 4, which is the start point of the hub 2, to the node 5. On the other hand, the backward position 1004 is the cost “13” of the link from the node 6, which is the end point of the hub 2, to the node 5.

The cost to connection point 1005 is “22” that is the sum of the cost of the link from the node 5 to the node 3 and the cost of the node. This is the sum of the cost “12” of the link from the node 5 to the node 2, the cost “0” of the node 2, and the cost “10” of the link from the node 2 to the node 1. Label data E (see FIG. 10) thus generated is recorded in the destination-side label data 1000.

Although detailed description is omitted, label data F illustrated in FIG. 10 is also generated by the same processing as described above. The label data F is label data in a case where the destination is the node 3 and the connection point is the node 6, and the forward position 1003 is “21”, the backward position 1004 is “0”, the cost to connection point 1005 is “12”, the forward connection cost 1006 is “0”, and the backward connection cost 1007 is “0”.

FIG. 14 is an explanatory diagram of a method of calculating the forward connection cost 906 on the departure side by the preliminary search unit 107 of the traffic simulation device 100 according to the embodiment of the present invention.

As described with reference to FIG. 9, in the present embodiment, in order to calculate the forward connection cost 906 and the backward connection cost 907, the cost for traveling straight through the node is subtracted. The reason why this subtraction is necessary will be described with reference to FIG. 14.

FIG. 9 illustrates an example of calculation of the cost of a route from the departure node 7 to the destination node 3 via the hub 2 on the road network 300. In this example, the connection point on the departure side is the node 5, and the connection point on the destination side is the node 6. This route corresponds to a combination of the label data B illustrated in FIG. 9 and the label data F illustrated in FIG. 10.

In this case, the cost of the route from the node 7 to the node 3 sequentially via the nodes 8, 5, and 6 can be calculated based on (a) the cost to the departure-side label connection point+ (b) the departure-side label forward connection cost+ (c) the cost on the hub+ (d) the destination-side label forward connection cost+ (e) the cost to the destination-side label connection point.

In a case where these are calculated from the label data B and F, “22” is obtained as (a) the cost to the departure-side label connection point from the cost to connection point 905 of the label data B illustrated in FIG. 9. As (d) the destination-side label forward connection cost and (e) the cost to the destination-side label connection point, “0” and “12” are obtained from the forward connection cost 1006 and the cost to connection point 1005 of the label data F illustrated in FIG. 10, respectively.

(c) the cost on the hub is calculated based on (g) the destination-side label forward position-(f) the departure-side label forward position. This is “11” obtained by subtracting “10” which is the forward position 903 of the label data B from “21” which is the forward position 1003 of the label data F. However, as illustrated in FIG. 14, (g)-(f)=“11” includes (h) the cost of passing on the hub, that is, the cost “1” of entering the node 5 from the node 4 and exiting to the node 6. On the other hand, since the above route enters the node 5 from the node 8 and exits to the node 6, the cost thereof is “50” (see FIG. 5).

Therefore, if “50” is used as (b) the departure-side label forward connection cost and “11” is used as (c) the cost on the hub, the total cost of (a) to (e) includes an unnecessary cost that is not to be added, such as (h) the cost “1” of passing on the hub.

In the present embodiment, the value of (b) the departure-side label forward connection cost is “49” obtained by subtracting the cost “1” of the node 5 when entering the node 5 from the node 4 and exiting to the node 6 from the cost “50” of the node 5 when entering the node 5 from the node 8 and exiting to the node 6. Accordingly, it is possible to delete unnecessary costs and perform a route search based on accurate costs.

In the above example, the connection cost on the departure side is adjusted in order to delete unnecessary costs. However, since it is only necessary to calculate an accurate cost value in the end, for example, the connection cost on the destination side instead of the departure side may be adjusted, or adjustment may be made by another method.

Next, processing executed by the route decision unit 103 of the traffic simulation device 100 will be described. The processing of the route decision unit 103 is executed with reference to the label data 111 generated in advance after the trip generation unit 102 generates the OD pair 122 (that is, a set of the departure and the destination).

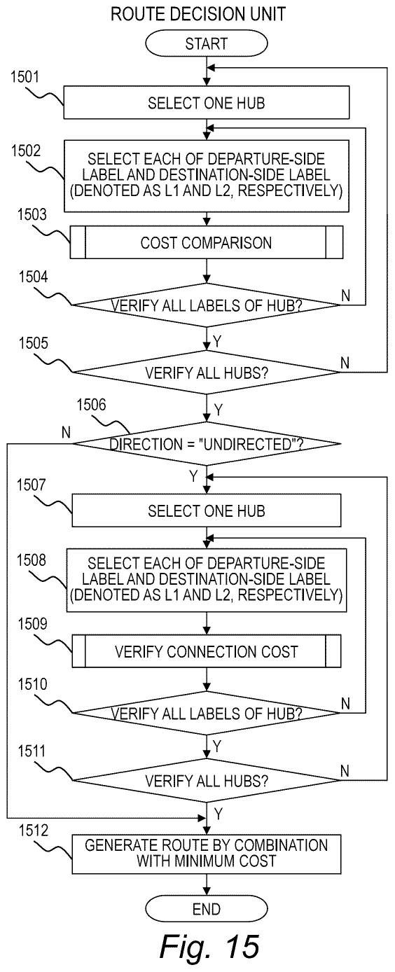

FIG. 15 is a flowchart illustrating an example of the processing executed by the route decision unit 103 of the traffic simulation device 100 according to the embodiment of the present invention.

First, the route decision unit 103 selects one hub with reference to the hub data 800 of the label data 111 (step 1501).

Next, the route decision unit 103 selects one label for each of the departure side and the destination side connected to the selected hub (step 1502). Specifically, one label in which the hub ID 902 is the identification number of the hub selected in step 1501 is selected from the departure-side label data 900, and similarly, one label in which the hub ID 1002 is the identification number of the hub selected in step 1501 is selected from the destination-side label data 1000. Hereinafter, the departure-side label and the destination-side label selected in step 1502 are described as a label L1 and a label L2, respectively.

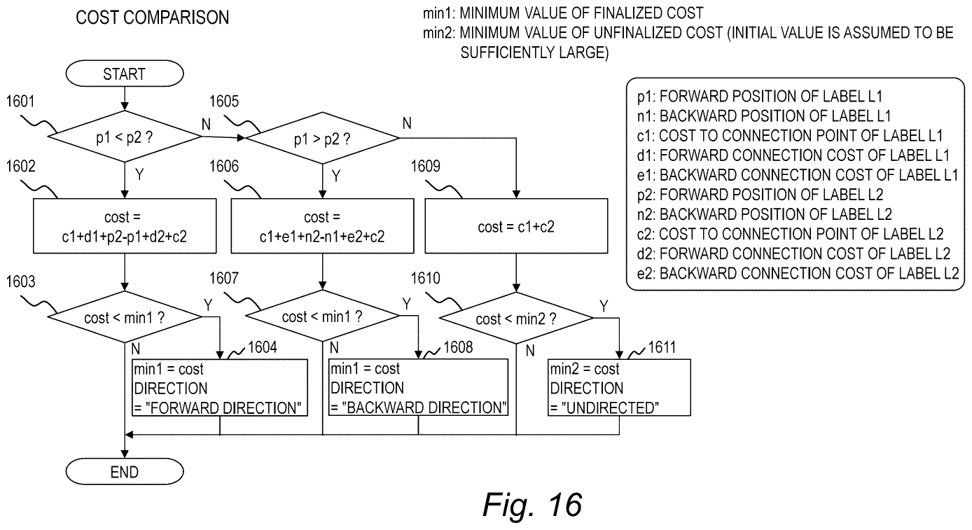

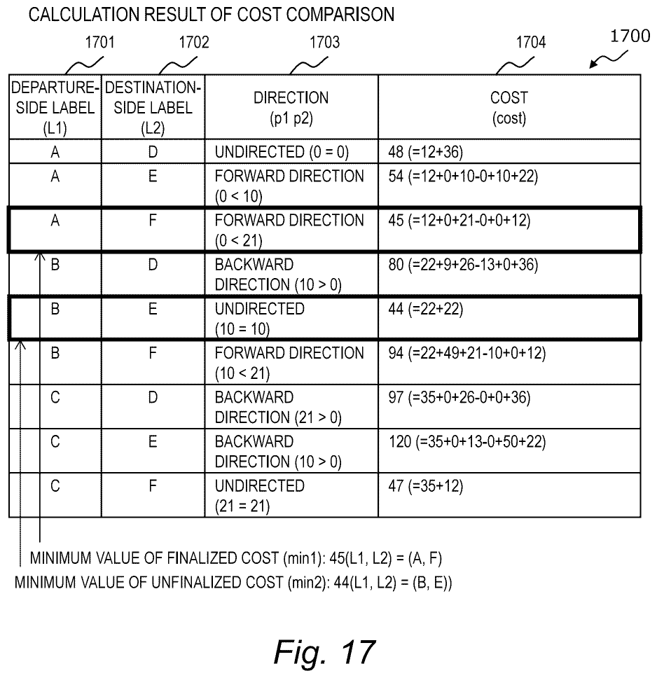

Next, the route decision unit 103 compares the cost of the route identified by the label L1 and the label L2 (step 1503). This processing will be described with reference to FIGS. 16 and 17.

FIG. 16 is a flowchart illustrating an example of cost comparison processing executed by the route decision unit 103 of the traffic simulation device 100 according to the embodiment of the present invention.

Parameters referred to in the processing of FIG. 16 are defined as follows.
p1: Value of forward position 903 of label L1
n1: Value of backward position 904 of label L1
c1: Value of cost to connection point 905 of label L1
d1: Value of forward connection cost 906 of label L1
e1: Value of backward connection cost 907 of label L1
p2: Value of forward position 1003 of label L2
n2: Value of backward position 1004 of label L2
c2: Value of cost to connection point 1005 of label L2
d2: Value of forward connection cost 1006 of label L2
e2: Value of backward connection cost 1007 of label L2

Further, the minimum value of the cost is defined as follows.
min1: Minimum value of finalized cost
min2: Minimum value of unfinalized cost

It is assumed that the initial values of both min1 and min2 are sufficiently large.

First, the route decision unit 103 determines whether p2 is larger than p1 (step 1601). The fact that p2 is larger than p1 means that the connection point on the destination side is located downstream of the connection point on the departure side, in other words, the traveling direction in the hub of the vehicle entering the hub from the connection point on the departure side and exiting from the hub through the connection point on the destination side is the forward direction.

In a case where p2 is larger than p1 (step 1601: Yes), the route decision unit 103 calculates the cost by the following formula (step 1602).

cost=c1+d1+p2−p1+d2+c2

Note that each term in the above formula corresponds to (a) to (g) illustrated in FIG. 14 as follows.
c1: (a)
d1: (b)
p2-p1: (g)-(f)
d2: (d)
c2: (e)

Next, the route decision unit 103 determines whether the value of cost calculated in Step 1602 is smaller than min1 (Step 1603). In a case where the value of cost is smaller than min1 (step 1603: Yes), since the value of cost is the current minimum value, the route decision unit 103 updates min1 to the value of cost and stores the direction as “forward direction” (step 1604).

In a case where p2 is not larger than p1 (step 1601: No), the route decision unit 103 determines whether p1 is larger than p2 (step 1605). The fact that p1 is larger than p2 means that the connection point on the destination side is located upstream of the connection point on the departure side, in other words, the traveling direction in the hub of the vehicle entering the hub from the connection point on the departure side and exiting from the hub through the connection point on the destination side is the backward direction.

In a case where p1 is larger than p2 (step 1605: Yes), the route decision unit 103 calculates the cost by the following formula (step 1606).

cost=c1+e1+n2−n1+e2+c2

Next, the route decision unit 103 determines whether the value of cost calculated in Step 1606 is smaller than min1 (Step 1607). In a case where the value of cost is smaller than min1 (step 1607: Yes), since the value of cost is the current minimum value, the route decision unit 103 updates min1 to the value of cost and stores the direction as “backward direction” (step 1608).

In a case where it is determined in step 1601 that p2 is not larger than p1 (step 1601: No) and it is determined in step 1605 that p1 is not larger than p2 (step 1605: No), p1=p2. This means that the connection point on the departure side and the connection point on the destination side are the same node, in other words, the vehicle that has entered the hub from the connection point on the departure side exits from the hub through the connection point without passing through the link in the hub.

In this case, the route decision unit 103 calculates the cost by the following formula (step 1609).

cost=c1+c2

Next, the route decision unit 103 determines whether the value of cost calculated in Step 1609 is smaller than min2 (Step 1610). The cost calculated in step 1609 is an unfinalized value that does not include the cost of the connection point node of the hub, and the cost of the actual route may be further increased. Therefore, in step 1610, the value of cost is compared with not min1 but min2. In a case where the value of cost is smaller than min2 (step 1607: Yes), since the value of cost is the minimum value among unfinalized costs at the current time, the route decision unit 103 updates min2 to the value of cost and stores the direction as “undirected” (step 1611).

Hereinbefore, the processing of comparing the cost of the route identified by the label L1 and the label L2 (step 1503 in FIG. 15) ends.

Next, the route decision unit 103 determines whether verification has been completed for all the labels connected to the selected hub (step 1504). In a case where there is a label that has not been verified yet (step 1504: No), the route decision unit 103 returns to step 1502, selects a label that has not been verified yet, and executes the processing of step 1503 and subsequent steps.

In a case where verification has been completed for all the labels connected to the selected hub (step 1504: Yes), the route decision unit 103 determines whether verification has been completed for all the hubs (step 1505). In a case where a hub that has not been verified yet (step 1505: No), the route decision unit 103 returns to step 1501, selects a hub that has not been verified yet, and executes the processing of step 1502 and subsequent steps.

Here, an example of results of the processing up to step 1505 will be described with reference to FIG. 17.

FIG. 17 is an explanatory diagram illustrating an example of a result of cost comparison processing executed by the route decision unit 103 of the traffic simulation device 100 according to the embodiment of the present invention.

FIG. 17 illustrates, as an example, a calculation result 1700 of cost comparison in a case where the node 7 is a departure and the node 3 is a destination in the road network 300 illustrated in FIG. 7. Here, in order to simplify the description, only a calculation result when the hub 2 is selected is illustrated.

The calculation result 1700 includes a departure-side label (L1) 1701, a destination-side label (L2) 1702, a direction 1703, and a cost 1704. All combinations of the label data A to C illustrated in FIG. 9 and the label data D to F illustrated in FIG. 10 are recorded in the departure-side label 1701 and the destination-side label 1702. In the combination of the respective pieces of label data, the direction 1703 is “forward direction” when p1<p2, is “backward direction” when p1>p2, and is “undirected” when p1=p2. In the cost 1704, the value of cost calculated in step 1602, 1606, or 1609 is recorded.

In the example of FIG. 17, the cost of the combination of the label data A and F is min1, and the cost of the combination of the label data B and E is min2. The former is the smallest of the costs 1704 of combinations of label data in which the direction 1703 is not “undirected”, and the latter is the smallest of the costs 1704 of combinations of label data in which the direction 1703 is “undirected”.

In this example, min1=45 and min2=44, and min2 is smaller at this point. However, as described above, min2 does not include the cost of the connection point node. Therefore, depending on the magnitude of the cost of the connection point node, the cost of the actual route of the combination of the label data B and E may remain less than min1, but may also be greater than min1.

FIG. 15 is referred to again. In a case where it is determined in step 1505 that verification has been completed for all the hubs (step 1505: Yes), the route decision unit 103 determines whether the direction is “undirected” (step 1506). Specifically, for example, as illustrated in FIG. 17, in a case where min2 is smaller than min1, it is determined that the direction is “undirected”, and otherwise, it is determined that the direction is not “undirected”.

In a case where it is determined in step 1506 that the direction is not “undirected”, that is, min2 is larger than or equal to min1 (step 1506: No), even if the accurate cost of the route is calculated by including the cost of the connection point node in min2, there is no possibility that the value is smaller than min1. That is, in this case, even when min2 is an unfinalized value not including the cost of the connection point node, min1 can be determined to be the minimum cost of all the routes without calculating the accurate value including the cost of the connection point node. Therefore, the route decision unit 103 proceeds to step 1512 without executing steps 1507 to 1511 described later. In step 1512, a route is generated by the combination of the departure-side label and the destination-side label corresponding to min1.

In a case where it is determined in step 1506 that the direction is “undirected”, that is, min2 is less than min1 (step 1506: Yes), the route decision unit 103 selects one hub (step 1507), and selects one departure-side label (L1) and one destination-side label (L2) connected to the selected hub (step 1508). These are executed similarly to steps 1501 and 1502.

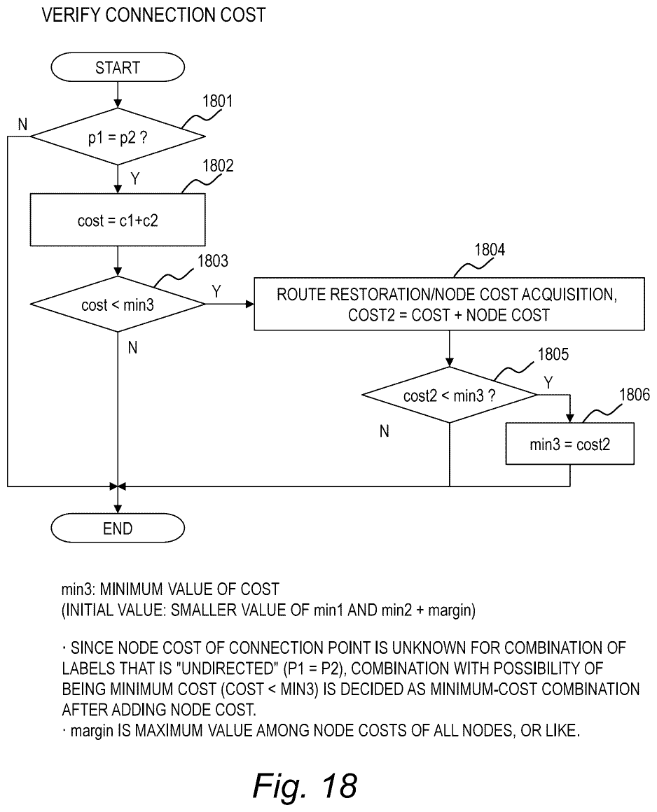

Next, the route decision unit 103 verifies the connection cost of the route identified by the label L1 and the label L2 (step 1509). This processing will be described with reference to FIG. 18.

FIG. 18 is a flowchart illustrating an example of connection cost verification processing executed by the route decision unit 103 of the traffic simulation device 100 according to the embodiment of the present invention.

In FIGS. 18, p1, p2, c1, and c2 are as illustrated in FIG. 16. First, the route decision unit 103 determines whether p1=p2 (step 1801). As described above, p1=p2 means that the connection point on the departure side and the connection point on the destination side are the same node, in other words, the vehicle that has entered the hub from the connection point on the departure side exits from the hub through the connection point without passing through the link in the hub.

In a case where p1=p2 is determined in step 1801 (step 1801: Yes), the route decision unit 103 calculates cost=c1+c2 similarly to step 1609 in FIG. 16 (step 1802).

Next, the route decision unit 103 determines whether the cost calculated in Step 1802 is smaller than min3 (whether cost<min3 is satisfied) (Step 1803). Here, min3 is the minimum value of the cost, and its initial value is the smaller value of min1 and min2+margin. The margin is, for example, a maximum value (“50” in the example of FIG. 5) of costs of nodes on the road network 300.

As described above, in a case where the combination of the departure-side label and the destination-side label satisfying p1=p2 is selected, the cost of the node on the hub cannot be identified from the label data. In a case where cost<min3 is satisfied, there is a possibility that the cost of the combination is the minimum, and thus, the combination of labels having the minimum cost is decided in addition to the cost of the node.

Specifically, in a case where cost<min3 is satisfied in step 1803 (step 1803: Yes), the route decision unit 103 restores a route based on the combination of the selected labels, acquires the node cost on the hub through which the route passes, and calculates cost2 by the following formula on the basis of the node cost (step 1804). This is a finalized cost calculated including the cost of the nodes on the hub.

cost2=cost+node cost

Next, the route decision unit 103 determines whether cost2 calculated in Step 1804 is smaller than min3 (whether cost2<min3 is satisfied) (Step 1805). In a case where cost2<min3 is satisfied (step 1805: Yes), the route decision unit 103 updates min3 to the value of cost2.

In a case where it is determined in step 1801 that p1=p2 is not satisfied (step 1801: No), it is not necessary to verify the connection cost, and thus, the processing of step 1802 and subsequent steps is not executed.

This is the end of the processing of verifying the connection cost (step 1509 in FIG. 15).

Next, the route decision unit 103 determines whether the verification of the connection cost has been completed for all the labels connected to the selected hub (step 1510). In a case where there is a label that has not been verified yet (step 1510: No), the route decision unit 103 returns to step 1508, selects a label that has not been verified yet, and executes the processing of step 1509 and subsequent steps.

In a case where the verification of the connection cost has been completed for all the labels connected to the selected hub (step 1510: Yes), the route decision unit 103 determines whether the verification of the connection cost has been completed for all the hubs (step 1511). In a case where there is a hub that has not been verified yet (step 1511: No), the route decision unit 103 returns to step 1507, selects a hub that has not been verified yet, and executes the processing of step 1508 and subsequent steps.

In a case where the verification of the connection cost has been completed for all the hubs (step 1511: Yes), the route decision unit 103 generates a route by a combination of the departure-side label and the destination-side label that minimizes the cost (step 1512).

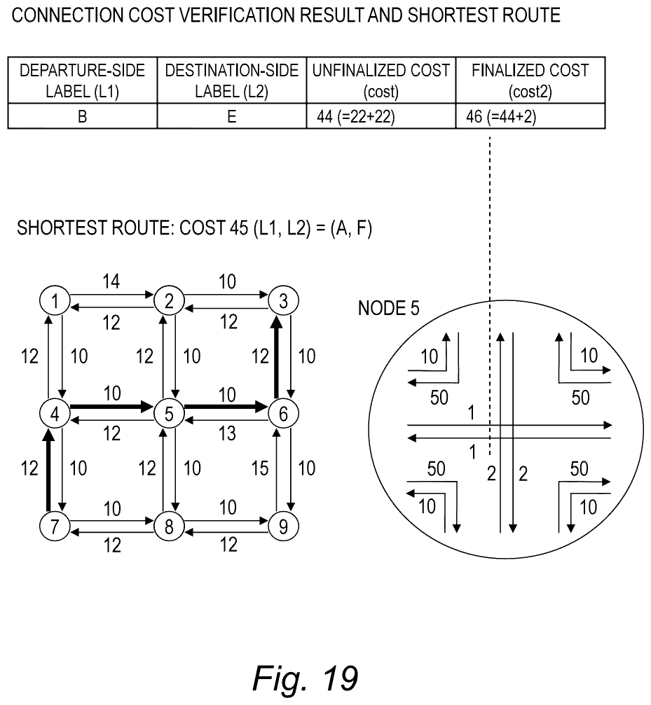

FIG. 19 is an explanatory diagram illustrating an example of a route generated by the route decision unit 103 of the traffic simulation device 100 according to the embodiment of the present invention.

FIG. 19 illustrates, as an example, a connection cost verification result and the shortest route based on the connection cost verification result in a case where the cost “45” of the combination of the departure-side label A and the destination-side label F is calculated as the minimum value (min1) of the finalized cost and the cost “44” of the combination of the departure-side label B and the destination-side label E is calculated as the minimum value (min2) of unfinalized cost as illustrated in FIG. 17.

In a case where the hub 2 is selected in step 1507 of FIG. 15 and the departure-side label B and the destination-side label E are selected in step 1508, p1=p2 is satisfied in the processing of FIG. 18 (step 1801: Yes), and cost=c1+c2=44 is calculated (step 1802). Here, when the margin is “50”, the initial value of min3 is the smaller one of “45” and “44+50”, that is, “45”, and cost<min3 is satisfied (step 1803: Yes).

The route decision unit 103 restores the route corresponding to the combination of the departure-side label B and the destination-side label E, and acquires the cost of the node on the hub through which the route passes (step 1804). In this example, a route from the departure node 7 to the destination node 3 sequentially via the nodes 8, 5, and 2 is restored. Since this route enters the node 5 on the hub from the node 8 and exits to the node 2, its cost is “2”. Therefore, the finalized cost (cost2) is “46” obtained by adding the cost “2” of the node 5 to “44” which is the unfinalized cost (cost).

Since the value “46” of this cost2 is larger than “45” which is the current min3 (step 1805: No), min3 is not updated. The route decision unit 103 generates a route corresponding to the combination of the departure-side label A and the destination-side label F with the lowest cost of “45” (step 1512). As illustrated in FIG. 19, this route is a route from the departure node 7 to the destination node 3 sequentially via the nodes 4, 5, and 6.

The processing in FIG. 18 is required only in the case of min2<min1 (step 1506: Yes), and the processing in step 1804 in FIG. 18 is required only in the case of cost<min3. A frequency at which these conditions are satisfied in the actual route search is low, and in most cases, the route search can be performed only by adding up the costs registered in advance in the label data. Even when the processing of FIG. 18 is required in rare cases, it is expected that the time required for the processing has a small influence on the entire processing time. Therefore, according to the present embodiment, high-speed route search by hub labeling can be performed with high accuracy in consideration of the cost of the node.

In addition, the system in the embodiments of the present invention may be configured as follows:

(1) In a route search method executed by a computer system (for example, the computer system 200 that implements a traffic simulation device) including a processor (for example, the processor 201) and a storage device (for example, the memory 202 and the auxiliary storage device 203), the storage device stores link cost data (for example, the link cost data 112) including a cost of a link included in a road network and node cost data (for example, the node cost data 113) including a cost of a node included in the road network, the route search method includes: a preliminary search procedure (for example, the processing in FIG. 11A) in which the processor generates label data (for example, the label data 111, that is, the hub data 800, the departure-side label data 900, and the destination-side label data 1000) on the basis of the link cost data and the node cost data; and a route decision procedure (for example, processing in FIG. 15) in which the processor decides a route between points on the basis of the label data, the preliminary search procedure includes a first procedure (for example, step 1101) in which the processor generates information regarding a hub (for example, the hub data 800) including one or more nodes of the road network, on the basis of the link cost data and the node cost data, and a second procedure (for example, step 1103) in which the processor stores, for each node included in the road network, a cost at which a route connecting each node and the hub is connected to the hub, the cost being included in the label data, on the basis of the link cost data and the node cost data, and the route decision procedure includes a third procedure (for example, the processing in FIG. 15) in which the processor decides the route between the points with reference to a cost on the hub, a cost of a route connected to the hub, and a cost at which the route is connected to the hub.

Accordingly, it is possible to perform a highly accurate route search also including the cost of each node, while reducing the time required for the route search after the departure and the destination are identified.

(2) In the route search method according to (1), in the information regarding the hub, a direction away from a start point of each hub among traveling directions in each hub is defined as a forward direction, and a direction toward the start point is defined as a backward direction, the second procedure includes a procedure (for example, step 1111) in which the processor generates, as the label data (for example, the departure-side label data 900), a departure-side label for each combination of a departure node and the hub, and a procedure (for example, step 1112) in which the processor generates a destination-side label (for example, the destination-side label data 1000) for each combination of a destination node and the hub, the procedure of generating the departure-side label includes a procedure in which the processor acquires a cost to a connection point on a departure side (for example, the cost to connection point 905), a forward connection cost on the departure side (for example, the forward connection cost 906), and a backward connection cost on the departure side (for example, a backward connection cost 907) for each combination of the departure node and the hub, the procedure of generating the destination-side label includes a procedure in which the processor acquires a cost to a connection point on a destination side (for example, the cost to connection point 1005), a forward connection cost on the destination side (for example, the forward connection cost 1006), and a backward connection cost on the destination side (for example, the backward connection cost 1007) for each combination of the destination node and the hub, the cost to the connection point on the departure side includes a cost of a route from the departure node to the hub,
the forward connection cost on the departure side includes, in a case where a route from the departure node to the hub passes through the hub in a forward direction from a connection point on the departure side which is a node connected to the hub, a cost of the node of the connection point, the backward connection cost on the departure side includes, in a case where the route from the departure node to the hub passes through the hub in a backward direction from the connection point on the departure side, a cost of the node of the connection point, the cost to the connection point on the destination side includes a cost of a route from the hub to the destination node, the forward connection cost on the destination side includes, in a case where a route from the hub to the destination node passes through the hub in the forward direction toward a connection point on the destination side which is a node connected to the hub, a cost of the node of the connection point, the backward connection cost on the destination side includes, in a case where a route from the hub to the destination node passes through the hub in the backward direction toward the connection point on the destination side, a cost of the node of the connection point, and the third procedure includes a procedure (for example, step 1502) in which the processor selects a combination of the departure-side label of the route from the departure node to the hub and the destination-side label of the route from the hub to the destination node, on the basis of the label data, and a procedure (for example, steps 1503 to 1512) in which the processor decides the cost for connecting to the hub by referring to the forward connection cost on the departure side and the forward connection cost on the destination side in a case where a position of the connection point on the destination side is farther from the start point of the hub than a position of the connection point on the departure side in the selected combination, and by referring to the backward connection cost on the departure side and the backward connection cost on the destination side in a case where the position of the connection point on the destination side is closer to the start point of the hub than the position of the connection point on the departure side.

Accordingly, it is possible to implement a route search based on an accurate cost by performing calculation including the cost of the node when necessary, and it is possible to shorten the time required for the route search by omitting the calculation when unnecessary.

(3) In the route search method according to (2), the third procedure includes a procedure (for example, step 1602 or step 1606) in which, in a case where the position of the connection point on the departure side and the position of the connection point on the destination side are not the same in the selected combination (for example, step 1601: Yes, or step 1601: No and step 1605: Yes), the processor decides a cost of a route corresponding to the combination, on the basis of values included in the selected departure-side label and destination-side label, and a procedure (for example, the processing of FIG. 18) in which, in a case where the position of the connection point on the departure side and the position of the connection point on the destination side are the same in the selected combination (for example, step 1601: No and step 1605: No), the processor retrieves a node cost of the connection point from the node cost data, and decides a cost of a route corresponding to the combination on the basis of the retrieved node cost and the values included in the selected departure-side label and destination-side label.

Accordingly, it is possible to implement a route search based on an accurate cost by performing calculation including the cost of the node when necessary, and it is possible to shorten the time required for the route search by omitting the calculation when unnecessary.

(4) In the route search method according to (3), the third procedure includes a procedure (for example, step 1602) in which, in a case where the position of the connection point on the destination side is farther from the start point of the hub than the position of the connection point on the departure side in the selected combination (for example, step 1601: Yes), the processor decides, as a finalized cost of a route corresponding to the combination, a sum of the cost to the connection point on the departure side, the forward connection cost on the departure side, a cost from the connection point on the departure side to the connection point on the destination side, the forward connection cost on the destination side, and the cost to the connection point on the destination side, a procedure (for example, step 1606) in which, in a case where the position of the connection point on the destination side is closer to the start point of the hub than the position of the connection point on the departure side in the selected combination (for example, step 1601: No and step 1605: Yes), the processor decides, as the finalized cost of the route corresponding to the combination, a sum of the cost to the connection point on the departure side, the backward connection cost on the departure side, the cost from the connection point on the departure side to the connection point on the destination side, the backward connection cost on the destination side, and the cost to the connection point on the destination side, a procedure (for example, step 1609) in which, in a case where the position of the connection point on the departure side and the position of the connection point on the destination side are the same in the selected combination (for example, step 1601: No and step 1605: No), the processor decides, as an unfinalized cost of the route corresponding to the selected combination, a sum of the cost to the connection point on the departure side and the cost to the connection point on the destination side, a procedure (for example, step 1512) in which, in a case where a minimum value of the finalized cost is equal to or less than a minimum value of the unfinalized cost (for example, step 1506: No), the processor decides a route corresponding to the minimum value of the finalized cost as a route from the departure node to the destination node, and a procedure (for example, step 1512) in which, in a case where the minimum value of the finalized cost is larger than the minimum value of the unfinalized cost (for example, step 1506: Yes), the processor compares the unfinalized cost with a smaller one of the minimum value of the finalized cost and a value obtained by adding a predetermined margin to the minimum value of the unfinalized cost, restores a route corresponding to the unfinalized cost in a case where the unfinalized cost is smaller (for example, step 1803: Yes), acquires a node cost on the hub through which the route passes, decides, as a finalized cost, a value obtained by adding the acquired node cost to the unfinalized cost (for example, step 1804), and decides a route corresponding to a minimum value of the finalized cost as the route from the departure node to the destination node.

Accordingly, it is possible to implement a route search based on an accurate cost by performing calculation including the cost of the node when necessary, and it is possible to shorten the time required for the route search by omitting the calculation when unnecessary.

(5) In the route search method according to (4), the second procedure includes a procedure in which, in any one of the departure-side label and the destination-side label, the processor decides values of the forward connection cost and the backward connection cost as values obtained by subtracting the cost of the node of the connection point when passing through the hub in the forward direction and the backward direction, respectively (for example, the value in (b) of FIG. 14 is set to 50−1=49), and the third procedure includes a procedure in which the processor calculates a difference between a cost from the start point of the hub to the connection point on the departure side and a cost from the start point of the hub to the connection point on the destination side (for example, (g)-(f) of FIG. 14) as a cost from the connection point on the departure side to the connection point on the destination side.

Accordingly, the value of the label is set so as to cancel the overlap of the cost of the node in the calculation of the cost of the route based on the label data, and accurate cost calculation can be performed with simple calculation.

Note that the present invention is not limited to the above-described embodiments, and includes various modifications. For example, the above-described embodiments have been described in detail for better understanding of the present invention, and are not necessarily limited to those having all the configurations of the description. In addition, a part of the configuration of a certain embodiment can be replaced with the configuration of another embodiment, and the configuration of another embodiment can be added to the configuration of a certain embodiment. In addition, a part of the configuration of each embodiment can be added, deleted, or replaced with another configuration.

In addition, some or all of the above-described configurations, functions, processing units, processing means, and the like may be implemented by hardware, for example, by designing with an integrated circuit. In addition, each of the above-described configurations, functions, and the like may be implemented by software by a processor interpreting and executing a program for realizing each function. Information such as a program, a table, and a file for realizing each function can be stored in a storage device such as a nonvolatile semiconductor memory, a hard disk drive, and a solid state drive (SSD), or a computer-readable non-transitory data storage medium such as an IC card, an SD card, and a DVD.

In addition, the control lines and the information lines indicate what is considered to be necessary for the description, and do not necessarily indicate all the control lines and the information lines on the product. In practice, it may be considered that almost all the configurations are connected to each other.

What is claimed is:

1. A route search method executed by a computer system including a processor and a storage device, wherein
the storage device stores link cost data including a cost of a link included in a road network and node cost data including a cost of a node included in the road network,
the route search method comprises:
a preliminary search procedure in which the processor generates label data on a basis of the link cost data and the node cost data; and
a route decision procedure in which the processor decides a route between points on a basis of the label data,
the preliminary search procedure includes
a first procedure in which the processor generates information regarding a hub including one or more nodes of the road network, on a basis of the link cost data and the node cost data, and
a second procedure in which the processor stores, for each node included in the road network, a cost at which a route connecting each node and the hub is connected to the hub, the cost being included in the label data, on a basis of the link cost data and the node cost data, and
the route decision procedure includes
a third procedure in which the processor decides the route between the points with reference to a cost on the hub, a cost of a route connected to the hub, and a cost at which the route is connected to the hub.

2. The route search method according to claim 1, wherein
in the information regarding the hub, a direction away from a start point of each hub among traveling directions in each hub is defined as a forward direction, and a direction toward the start point is defined as a backward direction,
the second procedure includes
a procedure in which the processor generates, as the label data, a departure-side label for each combination of a departure node and the hub, and a procedure in which the processor generates a destination-side label for each combination of a destination node and the hub,
the procedure of generating the departure-side label includes a procedure in which the processor acquires a cost to a connection point on a departure side, a forward connection cost on the departure side, and a backward connection cost on the departure side for each combination of the departure node and the hub,
the procedure of generating the destination-side label includes a procedure in which the processor acquires a cost to a connection point on a destination side, a forward connection cost on the destination side, and a backward connection cost on the destination side for each combination of the destination node and the hub,
the cost to the connection point on the departure side includes a cost of a route from the departure node to the hub,
the forward connection cost on the departure side includes, in a case where a route from the departure node to the hub passes through the hub in a forward direction from a connection point on the departure side which is a node connected to the hub, a cost of the node of the connection point,
the backward connection cost on the departure side includes, in a case where the route from the departure node to the hub passes through the hub in a backward direction from the connection point on the departure side, a cost of the node of the connection point,
the cost to the connection point on the destination side includes a cost of a route from the hub to the destination node,
the forward connection cost on the destination side includes, in a case where a route from the hub to the destination node passes through the hub in the forward direction toward a connection point on the destination side which is a node connected to the hub, a cost of the node of the connection point,
the backward connection cost on the destination side includes, in a case where a route from the hub to the destination node passes through the hub in the backward direction toward the connection point on the destination side, a cost of the node of the connection point, and
the third procedure includes
a procedure in which the processor selects a combination of the departure-side label of the route from the departure node to the hub and the destination-side label of the route from the hub to the destination node, on a basis of the label data, and
a procedure in which the processor decides the cost for connecting to the hub by referring to the forward connection cost on the departure side and the forward connection cost on the destination side in a case where a position of the connection point on the destination side is farther from the start point of the hub than a position of the connection point on the departure side in the selected combination, and by referring to the backward connection cost on the departure side and the backward connection cost on the destination side in a case where the position of the connection point on the destination side is closer to the start point of the hub than the position of the connection point on the departure side.

3. The route search method according to claim 2, wherein
the third procedure includes
a procedure in which, in a case where the position of the connection point on the departure side and the position of the connection point on the destination side are not the same in the selected combination, the processor decides a cost of a route corresponding to the combination, on a basis of values included in the selected departure-side label and destination-side label, and
a procedure in which, in a case where the position of the connection point on the departure side and the position of the connection point on the destination side are the same in the selected combination, the processor retrieves a node cost of the connection point from the node cost data, and decides a cost of a route corresponding to the combination on a basis of the retrieved node cost and the values included in the selected departure-side label and destination-side label.

4. The route search method according to claim 3, wherein
the third procedure includes
a procedure in which, in a case where the position of the connection point on the destination side is farther from the start point of the hub than the position of the connection point on the departure side in the selected combination, the processor decides, as a finalized cost of a route corresponding to the combination, a sum of the cost to the connection point on the departure side, the forward connection cost on the departure side, a cost from the connection point on the departure side to the connection point on the destination side, the forward connection cost on the destination side, and the cost to the connection point on the destination side,
a procedure in which, in a case where the position of the connection point on the destination side is closer to the start point of the hub than the position of the connection point on the departure side in the selected combination, the processor decides, as the finalized cost of the route corresponding to the combination, a sum of the cost to the connection point on the departure side, the backward connection cost on the departure side, the cost from the connection point on the departure side to the connection point on the destination side, the backward connection cost on the destination side, and the cost to the connection point on the destination side,
a procedure in which, in a case where the position of the connection point on the departure side and the position of the connection point on the destination side are the same in the selected combination, the processor decides, as an unfinalized cost of the route corresponding to the selected combination, a sum of the cost to the connection point on the departure side and the cost to the connection point on the destination side,
a procedure in which, in a case where a minimum value of the finalized cost is equal to or less than a minimum value of the unfinalized cost, the processor decides a route corresponding to the minimum value of the finalized cost as a route from the departure node to the destination node, and
a procedure in which, in a case where the minimum value of the finalized cost is larger than the minimum value of the unfinalized cost, the processor compares the unfinalized cost with a smaller one of the minimum value of the finalized cost and a value obtained by adding a predetermined margin to the minimum value of the unfinalized cost, restores a route corresponding to the unfinalized cost in a case where the unfinalized cost is smaller, acquires a node cost on the hub through which the route passes, decides, as a finalized cost, a value obtained by adding the acquired node cost to the unfinalized cost, and decides a route corresponding to a minimum value of the finalized cost as the route from the departure node to the destination node.

5. The route search method according to claim 4, wherein
the second procedure includes a procedure in which, in any one of the departure-side label and the destination-side label, the processor decides values of the forward connection cost and the backward connection cost as values obtained by subtracting the cost of the node of the connection point when passing through the hub in the forward direction and the backward direction, respectively, and
the third procedure includes a procedure in which the processor calculates a difference between a cost from the start point of the hub to the connection point on the departure side and a cost from the start point of the hub to the connection point on the destination side as a cost from the connection point on the departure side to the connection point on the destination side.

6. A route search device comprising:
a processor and a storage device, wherein
the storage device stores link cost data including a cost of a link included in a road network and node cost data including a cost of a node included in the road network,
the processor executes
a preliminary search procedure of generating label data on a basis of the link cost data and the node cost data, and
a route decision procedure in which the processor decides a route between points on a basis of the label data,
in the preliminary search procedure, the processor executes
a first procedure in which the processor generates information regarding a hub including one or more nodes of the road network, on a basis of the link cost data and the node cost data, and
a second procedure in which the processor stores, for each node included in the road network, a cost at which a route connecting each node and the hub is connected to the hub, the cost being included in the label data, on a basis of the link cost data and the node cost data, and
in the route decision procedure, the processor executes
a third procedure in which the processor decides the route between the points with reference to a cost on the hub, a cost of a route connected to the hub, and a cost at which the route is connected to the hub.

7. The route search device according to claim 6, wherein
in the information regarding the hub, a direction away from a start point of each hub among traveling directions in each hub is defined as a forward direction, and a direction toward the start point is defined as a backward direction,
in the second procedure, the processor executes
a procedure of generating, as the label data, a departure-side label for each combination of a departure node and the hub, and a procedure of generating a destination-side label for each combination of a destination node and the hub,
in the procedure of generating the departure-side label, the processor executes a procedure of acquiring a cost to a connection point on a departure side, a forward connection cost on the departure side, and a backward connection cost on the departure side for each combination of the departure node and the hub,
in the procedure of generating the destination-side label, the processor executes a procedure of acquiring a cost to a connection point on a destination side, a forward connection cost on the destination side, and a backward connection cost on the destination side for each combination of the destination node and the hub,
the cost to the connection point on the departure side includes a cost of a route from the departure node to the hub,
the forward connection cost on the departure side includes, in a case where a route from the departure node to the hub passes through the hub in a forward direction from a connection point on the departure side which is a node connected to the hub, a cost of the node of the connection point,
the backward connection cost on the departure side includes, in a case where the route from the departure node to the hub passes through the hub in a backward direction from the connection point on the departure side, a cost of the node of the connection point,
the cost to the connection point on the destination side includes a cost of a route from the hub to the destination node,
the forward connection cost on the destination side includes, in a case where a route from the hub to the destination node passes through the hub in the forward direction toward a connection point on the destination side which is a node connected to the hub, a cost of the node of the connection point,
the backward connection cost on the destination side includes, in a case where a route from the hub to the destination node passes through the hub in the backward direction toward the connection point on the destination side, a cost of the node of the connection point, and
in the third procedure, the processor executes
a procedure of selecting a combination of the departure-side label of the route from the departure node to the hub and the destination-side label of the route from the hub to the destination node, on a basis of the label data, and
a procedure of deciding the cost for connecting to the hub by referring to the forward connection cost on the departure side and the forward connection cost on the destination side in a case where a position of the connection point on the destination side is farther from the start point of the hub than a position of the connection point on the departure side in the selected combination, and by referring to the backward connection cost on the departure side and the backward connection cost on the destination side in a case where the position of the connection point on the destination side is closer to the start point of the hub than the position of the connection point on the departure side.

8. The route search device according to claim 7, wherein
in the third procedure, the processor executes
a procedure of, in a case where the position of the connection point on the departure side and the position of the connection point on the destination side are not the same in the selected combination, deciding a cost of a route corresponding to the combination, on a basis of values included in the selected departure-side label and destination-side label, and
a procedure of, in a case where the position of the connection point on the departure side and the position of the connection point on the destination side are the same in the selected combination, retrieving a node cost of the connection point from the node cost data, and deciding a cost of a route corresponding to the combination on a basis of the retrieved node cost and the values included in the selected departure-side label and destination-side label.

9. The route search device according to claim 8, wherein
in the third procedure, the processor executes
a procedure of, in a case where the position of the connection point on the destination side is farther from the start point of the hub than the position of the connection point on the departure side in the selected combination, deciding, as a finalized cost of a route corresponding to the combination, a sum of the cost to the connection point on the departure side, the forward connection cost on the departure side, a cost from the connection point on the departure side to the connection point on the destination side, the forward connection cost on the destination side, and the cost to the connection point on the destination side,
a procedure of, in a case where the position of the connection point on the destination side is closer to the start point of the hub than the position of the connection point on the departure side in the selected combination, deciding, as the finalized cost of the route corresponding to the combination, a sum of the cost to the connection point on the departure side, the backward connection cost on the departure side, the cost from the connection point on the departure side to the connection point on the destination side, the backward connection cost on the destination side, and the cost to the connection point on the destination side,
a procedure of, in a case where the position of the connection point on the departure side and the position of the connection point on the destination side are the same in the selected combination, deciding, as an unfinalized cost of the route corresponding to the selected combination, a sum of the cost to the connection point on the departure side and the cost to the connection point on the destination side,
a procedure of, in a case where a minimum value of the finalized cost is equal to or less than a minimum value of the unfinalized cost, deciding a route corresponding to the minimum value of the finalized cost as a route from the departure node to the destination node, and
a procedure of, in a case where the minimum value of the finalized cost is larger than the minimum value of the unfinalized cost, comparing the unfinalized cost with a smaller one of the minimum value of the finalized cost and a value obtained by adding a predetermined margin to the minimum value of the unfinalized cost, restoring a route corresponding to the unfinalized cost in a case where the unfinalized cost is smaller, acquiring a node cost on the hub through which the route passes, deciding, as a finalized cost, a value obtained by adding the acquired node cost to the unfinalized cost, and deciding a route corresponding to a minimum value of the finalized cost as the route from the departure node to the destination node.

10. The route search device according to claim 9, wherein
in the second procedure, the processor executes a procedure of, in any one of the departure-side label and the destination-side label, deciding values of the forward connection cost and the backward connection cost as values obtained by subtracting the cost of the node of the connection point when passing through the hub in the forward direction and the backward direction, respectively, and
in the third procedure, the processor executes a procedure of calculating a difference between a cost from the start point of the hub to the connection point on the departure side and a cost from the start point of the hub to the connection point on the destination side as a cost from the connection point on the departure side to the connection point on the destination side.
